(19) United States
(12) Patent Application Publication
(10) Pub. No.: US 2007/0017156 A1
(43) Pub. Date: Jan. 25, 2007

(54) Security Gate

(75) Inventors: Jon D. Robinson, Appleton, WI (US); Jeffery R. Prange, Cecil, WI (US)

Correspondence Address: MERCHANT & GOULD PC, P.O. BOX 2903, MINNEAPOLIS, MN, 55402-0903, US

(73) Assignee: North States Industries, Inc., Minneapolis, MN (US)

(21) Appl. No.: 11/458,928

(22) Filed: Jul. 20, 2006

Related U.S. Application Data
(60) Provisional application No. 60/701,224, filed on Jul. 21, 2005.

(51) Int. Cl. E06B 9/01

(52) U.S. Cl. 49/55

(57) ABSTRACT

A security gate includes a portion that extends at a non-vertical angle. The gate can include a first vertical portion, and a second non-vertical portion extending at an angle with respect to the first vertical portion. In other examples, a gate can include a vertical frame, and a non-vertical portion coupled to the frame.

### RELATED APPLICATION

This application claims the benefit of U.S. Patent Provisional Application Ser. No. 60/701,224 filed on Jul. 21, 2005, the entirety of which is hereby incorporated by reference.

### TECHNICAL FIELD

Embodiments of the present disclosure relate to security gates. More particularly, embodiments of the present disclosure relate to security gates for pets and children.

### BACKGROUND

Security gates are commonly used to lock or close passageways such as conventional doorways and entrances to stairwells. The purpose of such gates is primarily security, such as keeping small children from accessing stairwells that could present a hazard, and also confinement, such as confining a pet to a particular room during the night. Many types of child and pet security gates are available on the market today that range from the accordion style gates formed from lattice-connected wood slats to lightweight plastic injected molded gates that permit adjustment to width and closure.

A typical security gate is formed from one or more panels, each panel including a frame surrounding a mesh or other similar lattice structure formed therebetween. The mesh is typically used so that one can see through the gate when the gate is in place. Although manufacturers do not recommend the use of gates that can be scaled by a child or pet, it is not always possible to anticipate or minimize the chances of this occurring. It is therefore possible that these gates, while not designed in such a manner, can provide finger/foot and/or paw holds that allow the child or pet to scale the gate, thereby thwarting the security provided by the gate.

Techniques for addressing this problem have typically involved extending the vertical height of the panels of the gate so that a higher vertical climb is required to overcome the gate. However, this technique can be disadvantageous because the additional height of the gate can make it difficult to ship and stock prior to sale. In addition, the added height can make it difficult for the user to carry the gate from one location to another, and the increased height may not be sufficient to stop all children or pets from scaling the increased height.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to a security gate including a portion that extends at a non-vertical angle. In one embodiment, a gate includes a first vertical portion, and a second non-vertical portion extending at an angle with respect to the vertical portion. In another embodiment, a gate includes a vertical frame, and a non-vertical portion coupled to the frame.

### BRIEF DESCRIPTION OF THE DRAWINGS

Reference will now be made to the accompanying drawings, which are not necessarily drawn to scale, and wherein:

FIG. 1 is a side view of an example security gate;

FIG. 2 is an exploded side view of the gate of FIG. 1;

FIG. 3 is an exploded front view of the gate of FIG. 1;

FIG. 4 is a front view of a portion of another example security gate;

FIG. 5 is a front view of another example security gate;

FIG. 6 is a side view of the gate of FIG. 5;

FIG. 7 is a side view of a portion of the gate of FIG. 6;

FIG. 8 is a side view of an example hinge assembly of the gate of FIG. 5;

FIG. 9 is a front view of the hinge assembly of FIG. 8;

FIG. 10 is a side view of another example hinge assembly of the gate of FIG. 5;

FIG. 11 is a front view of the hinge assembly of FIG. 10;

FIG. 12 is a front view of another example security gate;

FIG. 13 is a side view of the gate of FIG. 12;

FIG. 14 is a side view of a portion of the gate of FIG. 13;

FIG. 15 is a front view of an example hinge assembly of the gate of FIG. 12;

FIG. 16 is a side view of the hinge assembly of FIG. 15;

FIG. 17 is a side view of another example security gate with a second portion in various folded positions;

FIG. 18 is a front view of another example security gate;

FIG. 19 is a side view of the gate of FIG. 18;

FIG. 20 is another front view of the gate of FIG. 18 with second portion in a folded position;

FIG. 21 is a side view of the gate of FIG. 20;

FIG. 22 is a front view of another example security gate; and

FIG. 23 is a side view of the gate of FIG. 22.

### DETAILED DESCRIPTION

Embodiments will now be described more fully hereinafter with reference to the accompanying drawings. Principles associated with this disclosure can, however, be embodied in many different forms and should not be construed as limited to the embodiments set forth herein. Instead, these embodiments are provided so that this disclosure will be thorough and complete, and will fully convey principles of the disclosure to those skilled in the art. Like numbers refer to like elements throughout.

Embodiments of the present disclosure relate to security gates, such as security gates for pets and children. Example gates described herein can include a portion that extends at a non-vertical angle to minimize the possibility that pets and/or children can scale the gates.

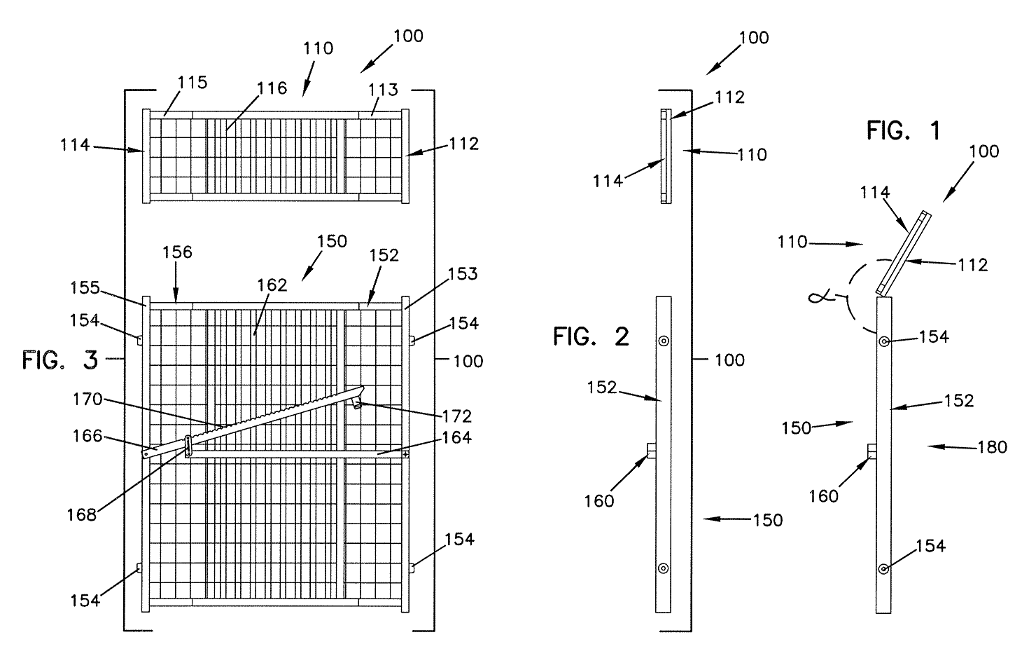

Referring now to FIGS. 1-3, a security gate 100 is shown. Gate 100 generally includes a first portion 150 and a second portion 110. Second portion 110 can be coupled to first portion 150 at a non-vertical angle. For example, first portion 150 can be positioned at a non-vertical angle extending towards a side 180 of gate 100 on which a pet or child is positioned, as described further below.

First portion 150 of gate 100 includes panels 152, 156. Each panel 152, 156 includes a frame 153, 155 surrounding a lattice structure formed by a mesh 162. Panels 152, 156 are slideably connected for adjustment to a desired width to define a closure between two stationary elements such as, for example, a doorjamb. In addition, a pair of rubber bumpers 154 is connected to the side face of each frame 153, 155 to frictionally engage the stationary elements.

Gate 100 also includes a locking structure 160 for locking panels 152, 156 at a desired width. Locking structure 160 includes a first arm 164 pivotally attached to frame 153 at a first end. A second arm 166 is pivotally attached to frame 155. A locking pin 168 attached to a second end of first arm 164 is configured to engage one of a plurality of notches 170 formed on an upper surface of second arm 166, and a mechanism 172 on a second end of second arm 166 is configured to engage and couple second arm 166 to first arm 164. Locking structure 160 is configured to position and maintain panels 152, 156 at the desired width by placing locking pin 168 in one of the notches 170 and locking mechanism 172 to first arm 164.

Second portion 110 of gate 100 includes panels 112, 114. Each panel 112, 114 includes a frame 113, 115 surrounding a lattice structure formed by a mesh 116 (e.g., similar to mesh 162). Like panels 152, 156, panels 112, 114 are slideably connected for adjustment to a desired width.

Generally, first portion 150 forms a vertical gate structure. Second portion 110 can be coupled to first portion 150 at a non-vertical angle (i.e., an angle less than or greater than 180 degrees), such as an angle α formed between second portion 110 and first portion 150 as shown in FIG. 1. In some embodiments, angle α is not adjustable. In other embodiments, angle α formed between second portion 110 and first portion 150 is adjustable.

For example, in some embodiments, second portion 110 can be moved from angle α=0 (e.g., second portion 110 lies flat against first portion 150 as shown in FIG. 17) through angle α=180. In some embodiments, second portion 110 can be fixed at one or a plurality of angles α between 0 and 360 degrees.

In some embodiments, first portion 150 and second portion 110 are fixedly coupled to one another using, for example, a hinge structure. In other embodiments, second portion 110 can be removably attached to first portion 150. For example, in some embodiments, second portion 110 can be configured to be attached or retrofitted onto a gate originally including only a vertical portion such as first portion 150. In this manner, second portion 110 can be an “add-on” that is coupled to a conventional vertical gate to add a non-vertical portion. For example, second 110 can include clips that allow second portion 110 to be coupled to and removed from first portion 150 at one or a variety of non-vertical angles.

Frames 153, 155 of first portion 150 and frames 113, 115 of second portion 110 can be made of a variety of materials, such as metal, plastic, or wood. In the example shown, frames 153, 155 and 113, 115 are made of wood. In other embodiments, frames 153, 155 and 113, 115 can be made of different materials. For example, frames 153, 155 can be made of wood, and frames 113, 115 can be made of metal or plastic.

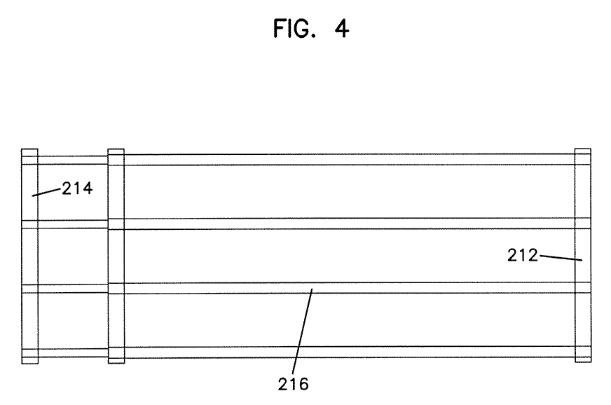

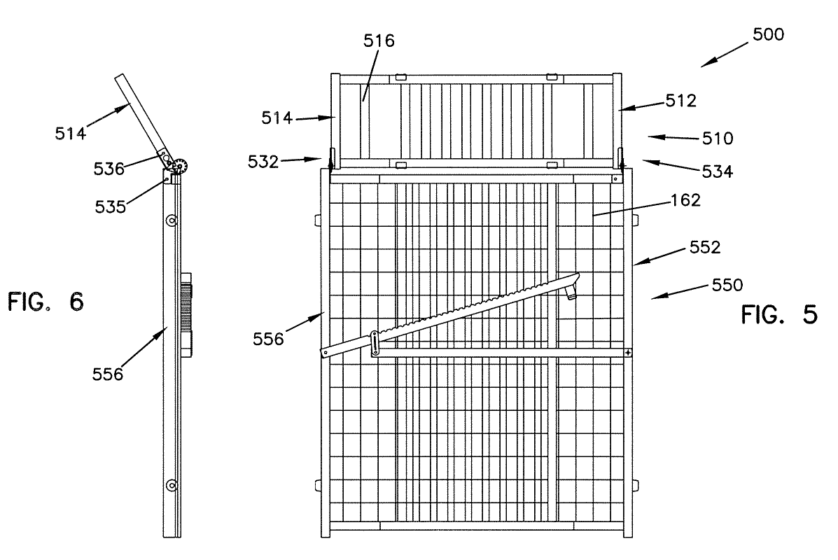

In addition, mesh 162 of first portion 150 and mesh 116 of second portion 110 can be configured in a variety of patterns and can be made of a variety of materials such as metal, plastic or wood. In the example shown, meshes 162, 116 form a lattice structure and are made from a vinyl-coated steel wire. In other embodiments, such as those shown in FIGS. 4 and 12-14, a mesh 216 of panels 212, 214 can be formed of telescoping tubes made of plastic. Other configurations are possible (see, for example, mesh 516 of FIGS. 5 and 6 with a vertical slat structure).

Although gate 100 is shown as an adjustable pressure-mounted gate in the examples herein, other types of gates can be used. For example, other types of pressure-mounted and hardware mounted gates can be used. Examples of such gates include, without limitation, pressure-mounted swing gates, accordion style gates, retractable mesh gates, and soft-sided gates. Other types of gates can be used.

Referring now to FIGS. 5-11, another embodiment of an example gate 500 is shown. Gate 500 is similar to gate 100, in that gate 500 includes a first vertical portion 550 with panels 552, 556, and a second non-vertical portion 510 with panels 512, 514. Gate 500 also includes hinge assemblies 532, 534 that rotational couple second portion 510 to first portion 550 at a plurality of angles.

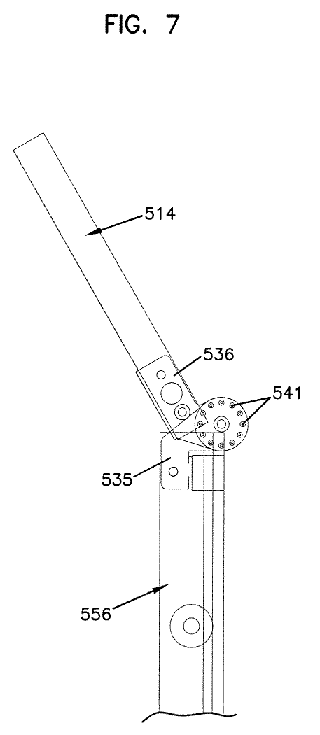

Referring specifically to FIGS. 7, 10, and 11, hinge assembly 532 includes a first member 535 coupled to panel 556 of first portion 550, and a second member 536 coupled to second portion 510. For example, first and second members 535, 536 can be coupled to first and second portions 550, 510 using fasteners such as rivets or screws (see FIG. 7). In the embodiment shown, a portion 531 can be coupled to couple vertical and horizontal members of the frame for panel 556. Other methods of attachment can be used.

First and second members 535, 536 are coupled at an end 537 by a fastener 538 such as a rivet or bolt. A spring washer 539 biases first member 535 toward second member 536. A plurality of protrusions 541 formed on first member 535 are forced by spring washer 539 into a corresponding plurality of apertures 540 formed by second member 536 to hold hinge assembly 532 (and attached panel 514) at a given angle. To change the angle, second member 536 can be rotated with respect to first member 535 to one of a plurality of angles. When a desired angle is reached, spring washer 539 forces protrusions 541 into corresponding apertures 540 to hold first and second members 535, 536 at the desired angle.

In the example shown, hinge assembly 532 defines a plurality of positions so that panel 514 can be held at a variety of angles α. In the example shown, hinge assembly 532 can hold panel 514 at one of a plurality of discrete positions. For example, in some embodiments, hinge assembly 532 includes between one and twelve discrete positions between angle α=180 degrees and angle α=360 degrees (e.g., at increments of 15, 30, 45, or 60 degrees) at which hinge assembly 532 can hold panel 514. In other embodiments, hinge assembly 532 is continuously adjustable so that panel 514 can be held at an infinite number of positions of varying 0<angle α<360 degrees, or 180<angle α<360 degrees.

In one example, panel 514 can be held at least at angle α that is between 180 and 360 degrees. In another example, panel 514 can be held at angle α that is between 210 and 250 degrees. In yet another example, panel 514 can be held at angle α that is approximately 225 degrees.

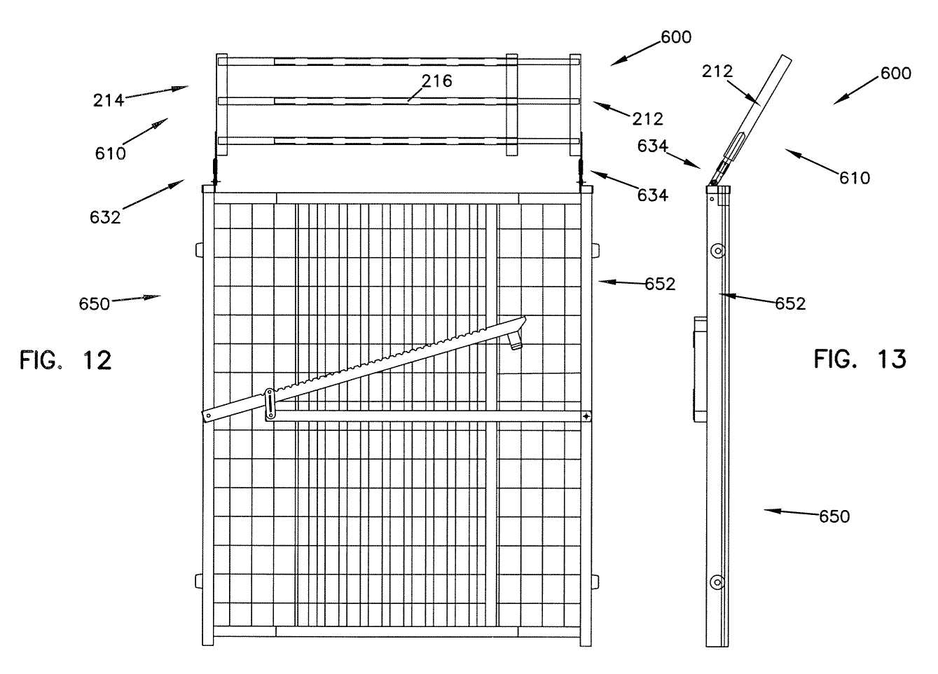

In the example shown, hinge assembly 532 allows panel 514 to be rotated in a direction X from a vertical downward position at which panel 514 generally overlaps and is parallel to panel 556 (see FIGS. 10 and 11) to a plurality of non-vertical angles (see FIGS. 5-7). In the example shown, hinge assembly 532 allows second member 536 to be pivoted until a surface 545 of second member 536 contacts a surface 547 of first member 535 (see FIG. 7). In this manner, a stop is provided so that second portion 510 does not rotate beyond a given angle in one direction and collapse against first portion 550 if a load (e.g., the weight of a pet or child) is placed on second portion 510.

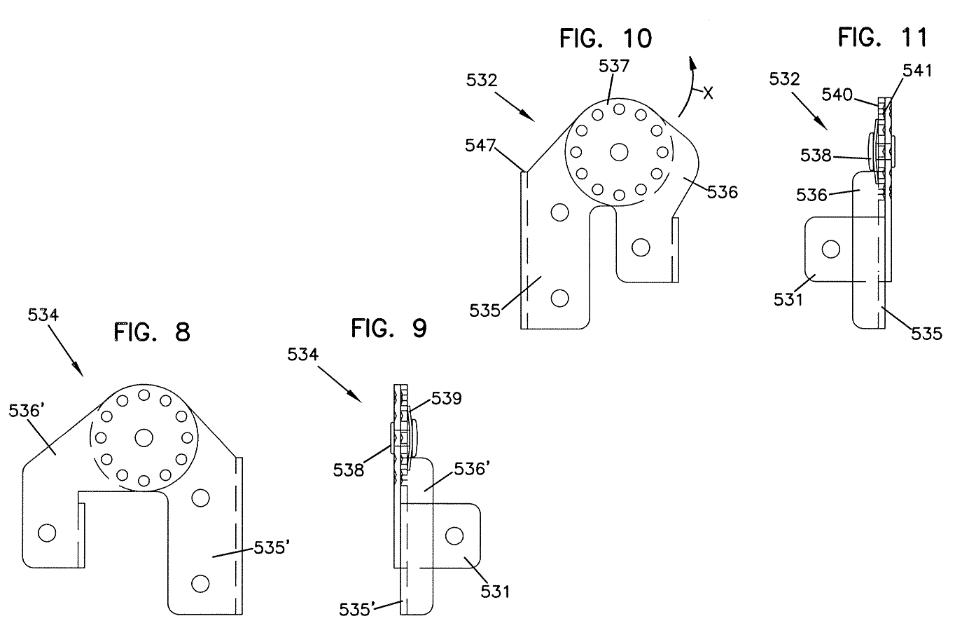

Hinge assembly 534, shown in FIGS. 8 and 9, is configured in a manner similar to that of hinge assembly 532. Hinge assembly 534 does differ in that the size and shape of first and second portions 535′ and 536′ are modified to allow first portion 535′ to be coupled to panel 552 of first portion 550 and to allow second portion 536′ to be coupled to panel 512 of second portion 510.

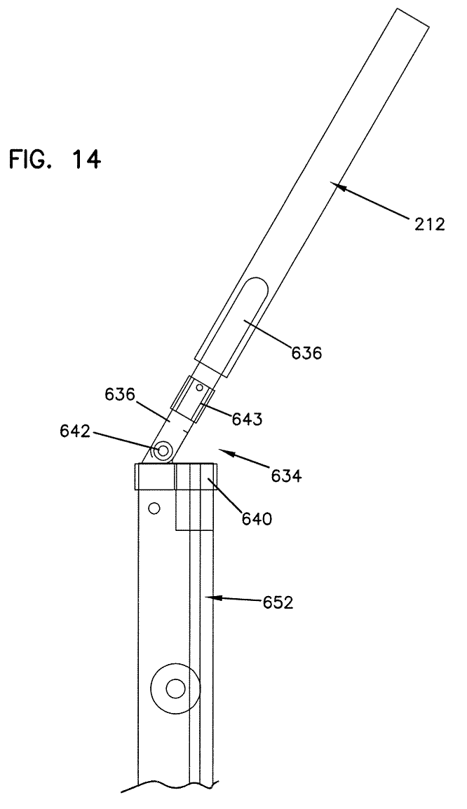

Referring now to FIGS. 12-16, another embodiment of an example gate 600 is shown. Gate 600 is similar to gates 100 and 500, in that gate 600 includes a first vertical portion 650 with panels 652, 656, and a second non-vertical portion 610 with panels 612, 614. Gate 600 also includes hinge assemblies 632, 634 that rotational couple second portion 610 to first portion 650.

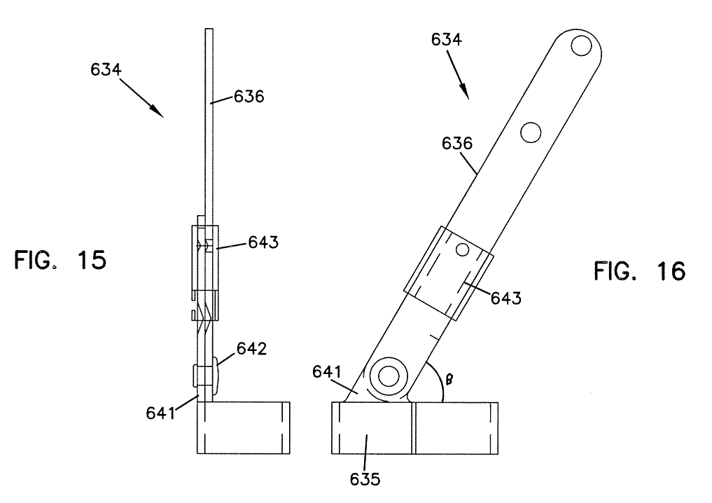

Referring specifically to FIGS. 14-16, hinge assembly 634 includes a first member 635 coupled to panel 652 of first portion 650, and a second member 636 coupled to second portion 610. For example, a base 640 of first member 635 is coupled to panel 652 by pressure-fitting base 640 around a portion of panel 652 (see FIG. 14). Second member 536 can be coupled to second portion 550 using fasteners such as rivets or screws. Other methods of attachment for first and second members 635, 636 can be used.

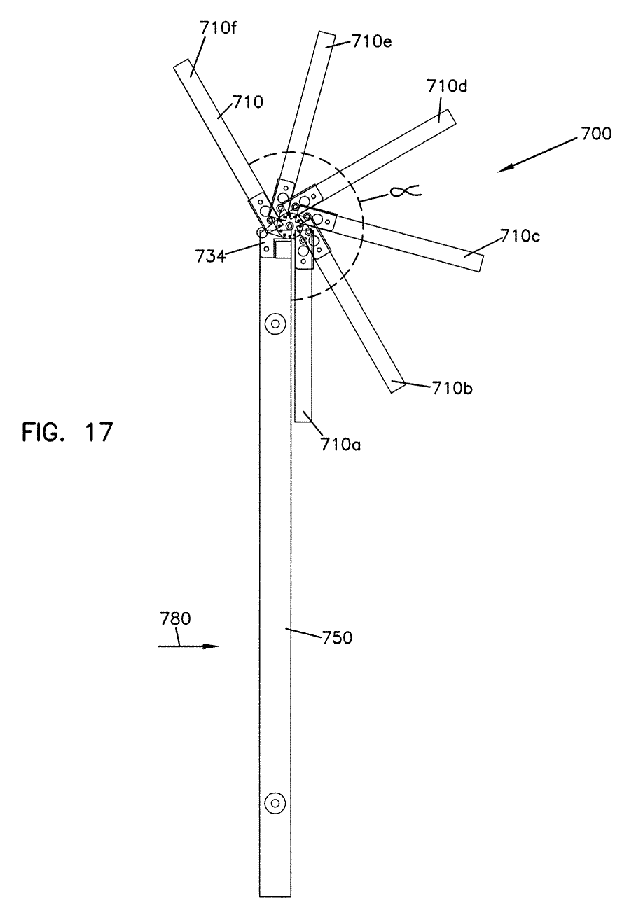

A non-vertical portion 641 extends from and is rigidly attached to base 640 of first member 635 at an angle β (see FIG. 16). In the example shown, base 640 and portion 641 are formed as an integral component. Second member 636 is coupled to first member 635 using a fastener 642 such as a rivet. A collar 643 slides along portion 641 of member 635 and member 636 to couple member 636 to portion 641 of member 635 at angle β. See FIGS. 14-16.

Collar 643 can be slid upwardly along member 636 until collar 643 clears portion 641 of member 635. At this point, member 636 (and attached panel 212) can be rotated about rivet 642 to a downward vertical position at which panel 212 of second portion 610 generally overlaps and is parallel to panel 652 of first portion 650. Member 636 can be recoupled to portion 641 of member 635 at angle β by rotating member 636 (and attached panel 212) so that member 636 is parallel to portion 641 of member 635, and sliding collar 643 downward to couple member 636 to portion 641.

Hinge assembly 632 is configured in a manner similar to that of hinge assembly 634.

Referring now to FIG. 17, another embodiment of an example gate 700 is shown. Gate 700 includes a second portion 710 coupled to a first portion 750 by an assembly 734. Assembly 734 can be similar to that of either hinge assembly 534 or 634.

Portion 710 is shown in a plurality of positions 710a-710. At position 710a, second portion 710 is rotated vertically downward in a storage position so that portion 710 generally overlaps and is parallel to portion 750. Such a position can be advantageous when gate 700 is not in use (e.g., when the gate 700 is being transported or is packaged for sale) so that the overall footprint of gate 700 is reduced. At position 710e, portion 710 is shown as rotated from the downward position of 710a to a substantially vertical position at angle α≈180 degrees. In some embodiments, portion 710 can be fixed in this vertical position, if desired. In other embodiments, portion 710 cannot be fixed in this position. At position 710f portion 710 has been rotated to an angle α beyond 180 degrees (e.g., α=225 degrees) with respect to the initial folded position shown in position 710a. In this position, portion 710 forms a non-vertical angle with respect to a side 780 of gate 700 on which the pet or child is positioned. Portion 710 can be fixed in this position, if desired. In some embodiments, portion 710 can be fixed in one of a plurality of positions 710a-710f, as described above.

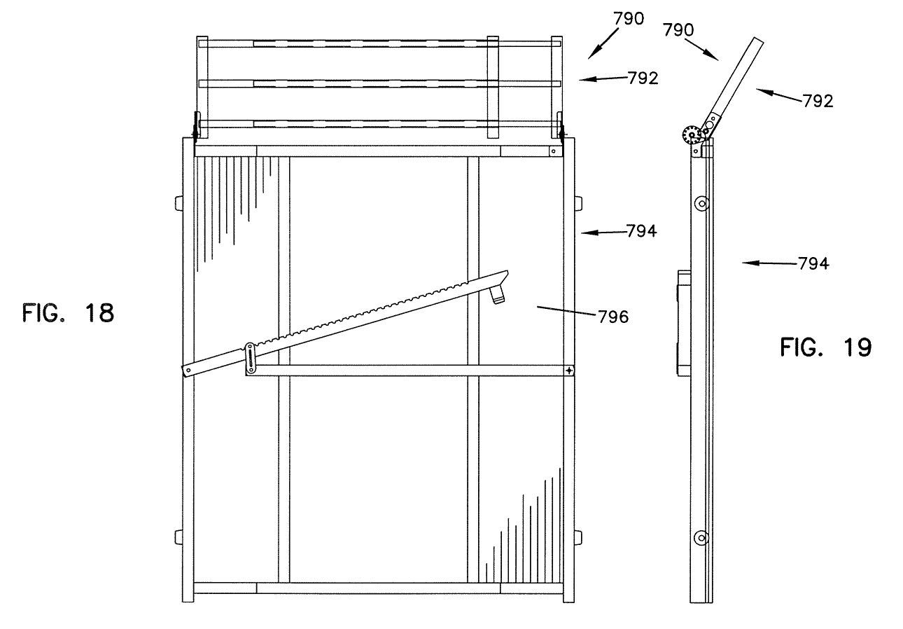

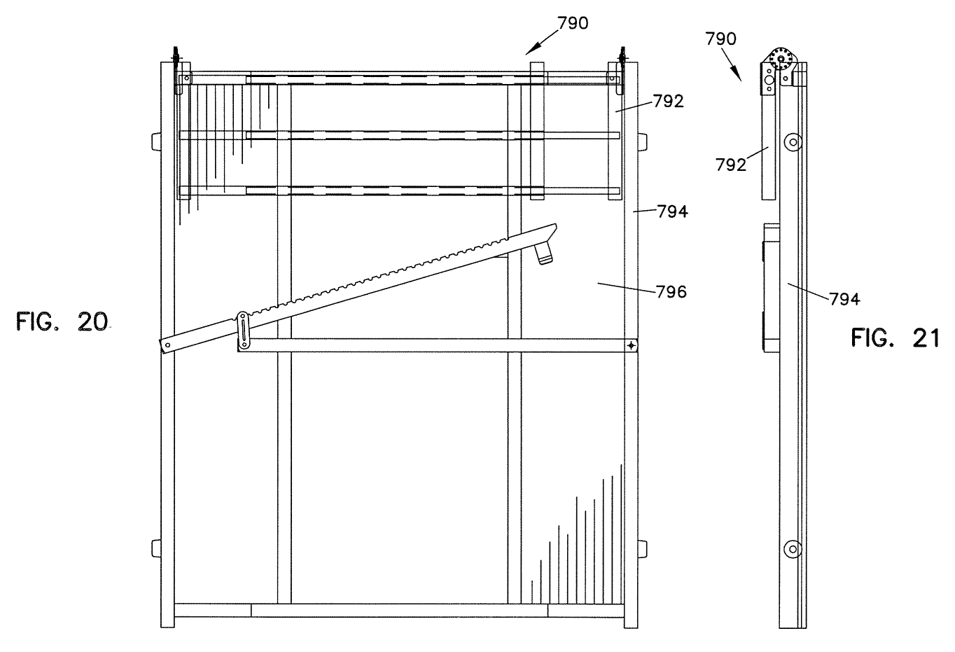

Referring now to FIGS. 18-21, another embodiment of an example gate 790 is shown. Gate 790 is similar to the gates described above and includes first and second portions 792, 794. However, instead of a mesh structure, second portion 794 includes a semi-transparent panel such as that shown in U.S. patent application Ser. No. 29/235,408 filed on Aug. 1, 2005, the entirety of which is hereby incorporated by reference. In alternative embodiments, first portion 792 can also be made of the semi-transparent material.

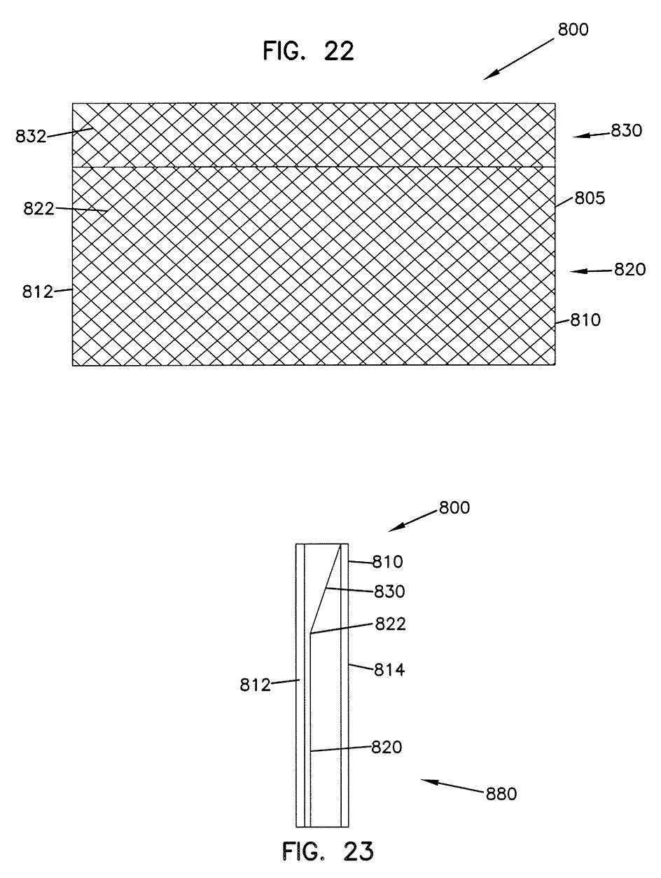

Referring now to FIGS. 22 and 23, another embodiment of an example gate 800 is shown. Gate 800 includes a panel 805 with a frame 810 including a first member 812 and a second member 814. A first portion 820 extends along first member 812, and a second portion 830 extends from adjacent an end 822 at a non-vertical angle to second member 814. Both first and second portions can include a mesh 822, 832, respectively. In this configuration, panel 805 includes both a vertical portion 820 and a non-vertical portion 830 extending towards a side 880 of gate 800 on which the pet or child is positioned. In some embodiments, gate 800 can include multiple panels configured in a manner similar to panel 805 to form an adjustable gate.

One or more advantages are associated with security gates including a portion that extends at a non-vertical angle as disclosed by the embodiments herein. For example, the non-vertical portion of the gate can be placed to extend towards the area in which the pet or child is restrained. In this manner, if an attempt to scale the gate is made, the pet or child encounters the angled portion. The angled portion minimizes the possibility that the pet or child can scale the gate. In some embodiments, the angle of the non-vertical portion can be changed. In some embodiments, the non-vertical portion can be rotated to extend downward to a storage position so that the angled portion generally overlaps and is parallel to the vertical portion. Such a position can be advantageous when the gate is not in use (e.g., when the gate is being transported or is packaged for sale) so that the overall footprint of gate is reduced.

The various embodiments described above are provided by way of illustration only and should not be construed to limit the disclosure. Those skilled in the art will readily recognize various modifications and changes that may be made to the present disclosure without following the example embodiments and applications illustrated and described herein, and without departing from the true spirit and scope of the present disclosure, which is set forth in the following claims.

What is claimed is:

1. A pressure-mounted gate, the gate comprising:
a first portion extending vertically; and
a second portion coupled to the first portion, the second portion extending at a non-vertical angle with respect to the first portion.

2. The gate of claim 1, wherein the second portion is fixed at the non-vertical angle.

3. The gate of claim 1, further comprising at least one hinge to rotatably couple the second portion to the first portion.

4. The gate of claim 3, wherein the second portion is rotatable relative to the first portion into a plurality of positions.

5. The gate of claim 3, wherein the second portion is rotated so that the second portion overlaps the first portion in a folded position.

6. The gate of claim 1, wherein the first portion and the second portion form a first panel, the first panel being in a sliding relationship with a second panel to form an adjustable width of the gate.

7. The gate of claim 1, wherein the first portion includes a lattice structure.

8. The gate of claim 1, wherein the first portion includes a semi-transparent panel.

9. A pressure-mounted gate, the gate comprising:
a first portion extending vertically, the first portion including first and second panels that overlap and slide horizontally relative to each other to form an adjustable width of the gate;
a second portion coupled to the first portion, the second portion including first and second panels that overlap and slide horizontally relative to each other; and
first and second hinges, the first hinge being positioned to couple the first panel of the first portion to the first panel of the second portion, and the second hinge being positioned to couple the second panel of the first portion to the second panel of the second portion;
wherein the first and second hinges allow the second portion to be rotated to a plurality of positions relative to the first portion, at least some of the positions resulting in the second portion extending at non-vertical angles with respect to the first portion.

10. The gate of claim 9, wherein the second portion is rotatable to a stored position wherein the second portion overlaps the first portion.

11. The gate of claim 9, wherein the first portion includes a lattice structure.

12. The gate of claim 9, wherein the first portion includes a semi-transparent panel.

13. An angled portion configured for use with a pressure-mounted gate including first and second panels that overlap and slide horizontally relative to each other, the angled portion comprising:
first and second angled panels that overlap and slide horizontally relative to each other; and
first and second hinges coupled to the first and second angled panels, respectively;
wherein the first hinge is configured to couple the first angled panel to the first panel of the gate, and the second hinge is configured to couple the second angled panel to the second panel of the gate; and
wherein the first and second hinges are configured to allow the angled portion to be rotated to a plurality of positions relative to the gate, at least some of the positions resulting in the angled portion extending at non-vertical angles with respect to the gate.

14. A method for manufacturing a gate, the method comprising:
positioning first and second panels of a first portion of the gate so that the first and second panels slide relative to each other to form an adjustable width of the gate;
positioning first and second panels of a second portion of the gate so that the first and second panels slide relative to each other; and
coupling the first portion to the second portion so that the second portion rotates to extend at a non-vertical angle with respect to the first portion.

15. The method of claim 14, further comprising rotating the second portion to a stored position wherein the second portion overlaps the first portion.

16. The method of claim 14, further comprising forming a lattice structure for the first and second panels of the first portion.

17. The method of claim 14, further comprising forming semi-transparent panels for the first and second panels of the first portion.
